(19) United States
(12) Patent Application Publication
(10) Pub. No.: US 2012/0105499 A1
(43) Pub. Date: May 3, 2012

(54) LIGHT-EMITTING ELEMENT DISPLAY DEVICE

(75) Inventors: Norihiro NAKAMURA, Mobara (JP); Hajime AKIMOTO, Kokubunji (JP)

(73) Assignees: CANON KABUSHIKI KAISHA; Hitachi Displays, Ltd.

(21) Appl. No.: 13/280,380

(22) Filed: Oct. 25, 2011

(30) Foreign Application Priority Data
Oct. 29, 2010 (JP) 2010-243498

(51) Int. Cl. G09G 5/10

(52) U.S. Cl. 345/690

(57) ABSTRACT

A light-emitting element display device includes: a gray level value luminance calculation unit that calculates the luminance to a gray level value from the setting values stored in a setting value storage unit; a voltage luminance storage unit that stores the measurement result of the luminance of a light-emitting element with respect to an applied voltage, a gray level value voltage information calculation unit that calculates the relationship between the gray level value and the voltage; and a DA converter unit that outputs a voltage corresponding to each gray level value. The DA converter unit includes a first ladder resistor unit and a second ladder resistor unit each including variable resistors, a third ladder resistor unit including a number of output terminals corresponding to the number of gray levels, and a gray level value voltage information register that stores the gray level value voltage information.

### CROSS-REFERENCE TO RELATED APPLICATION

The present application claims priority from Japanese application JP2010-243498 filed on Oct. 29, 2010, the content of which is hereby incorporated by reference into this application.

### BACKGROUND OF THE INVENTION

1. Field of the Invention

The present invention relates to a light-emitting element display device, and more particularly, to a light-emitting element display device that performs display by causing a light-emitting element which is a self luminous body to emit light.

2. Description of the Related Art

In recent years, an image display device which uses a self-luminous body called an organic light-emitting diode (hereinafter referred to as an “organic electro-luminescent (EL) display device”) has been practically used. Since the organic EL display device uses a self-luminous body, the organic EL display device is superior in visibility and response speed as compared to a liquid crystal display device of the related art. Moreover, the organic EL display device can be made thinner since it does not require an auxiliary illumination device such as a backlight.

JP2008-170788A discloses a method for driving an organic EL display device. JP2004-354625A discloses a driving circuit which includes a gray level voltage generation circuit and a control register for each of the three colors RGB, and which absorbs fluctuation of the characteristics of self-luminous elements between the respective colors RGB. Japanese Patent No. 4199141 discloses a method of generating a gray level voltage taking gamma correction into consideration.

### SUMMARY OF THE INVENTION

Although the brightness of an organic light-emitting diode changes with the amount of current flowing therein, the current-luminance characteristics are different for each color RGB, and the current-luminance characteristics also change due to errors during manufacturing. Moreover, as for a driving thin film transistor (TFT) that determines the amount of current flowing into the organic light-emitting diode, the gate voltage-current characteristics change due to manufacturing errors and a difference in designed values. In particular, since a difference occurs in the gate voltage at which light emission starts, a coloring (for example, red floating) may occur in the low gray level range such as during black display.

The present invention has been made in view of the problems, and an object of the present invention is to provide a light-emitting element display device capable of performing display reflecting the gray level value-voltage characteristics of a display device more accurately.

A light-emitting element display device according to an aspect of the present invention includes: a setting value storage unit that stores setting values regarding display quality; a gray level value luminance calculation unit that calculates the relationship between a gray level value and a luminance from the setting values stored in the setting value storage unit; a voltage luminance storage unit that stores the relationship between an applied voltage and the luminance of a light-emitting element, a gray level value voltage information calculation unit that calculates gray level value voltage information which is the relationship between the gray level value and the voltage using the information supplied from the gray level value luminance calculation unit and the voltage luminance storage unit; and a DA converter unit of which the output voltage is controlled by the calculated gray level value voltage information and which outputs a voltage corresponding to each gray level value, wherein the DA converter unit includes a first ladder resistor unit and a second ladder resistor unit each including a variable resistor, a third ladder resistor unit including a number of output terminals corresponding to the number of gray levels, and a gray level value voltage information register that stores the gray level value voltage information, and wherein the variable resistor is controlled by the gray level value voltage information stored in the gray level value voltage information register.

In the light-emitting element display device of the above aspect of the present invention, the first ladder resistor unit may receive an upper reference voltage and a lower reference voltage at both ends thereof and outputs a plurality of kinds of voltages, the second ladder resistor unit may receive the plurality of kinds of output voltages and outputs a number of voltages larger than the plurality of kinds of voltages received, and the third ladder resistor unit may receive the voltages output by the second ladder resistor unit and outputs a number of voltages corresponding to the number of gray levels.

In the light-emitting element display device of the above aspect of the present invention, in each of the first ladder resistor unit and the second ladder resistor unit, the number of output terminals in the upper 1/4 gray level range of the entire gray level range maybe larger than the number of output terminals in the lower 1/4 gray level range.

In the light-emitting element display device of the above aspect of the present invention, the first ladder resistor unit may output five kinds of voltages, the second ladder resistor unit may output eleven kinds of voltages, and the third ladder resistor unit may output 64 kinds of voltages which correspond in number to the number of gray levels.

In the light-emitting element display device of the above aspect of the present invention, the voltage luminance storage unit may independently store the luminances of the respective colors RGB.

### BRIEF DESCRIPTION OF THE DRAWINGS

FIG. 1 is a diagram showing an organic EL display device according to a first embodiment of the present invention.

FIG. 2 is a diagram schematically showing a thin film transistor (TFT) substrate shown in FIG. 1.

FIG. 3 is a diagram schematically showing the circuit of a pixel shown in FIG. 2.

FIG. 4 is a timing chart showing changes of respective signals in the pixel shown in FIG. 3.

FIG. 5 is a diagram schematically showing the configuration of a data signal driving unit shown in FIG. 2.

FIG. 6 is a graph showing an example of measurement data stored in a voltage luminance storage unit shown in FIG. 5.

FIG. 7 is a graph showing the relationship between a gray level value D and a gate voltage V for R (red).

FIG. 8 is a graph showing the relationship between a gray level value D and a gate voltage V for G (green).

FIG. 9 is a graph showing the relationship between a gray level value D and a gate voltage V for B (blue).

FIG. 10 is a diagram schematically showing the configuration of a DA converter unit shown in FIG. 5.

FIG. 11 is a diagram schematically showing the inner circuits of an R gray level voltage generation circuit shown in FIG. 10.

FIG. 12 is a diagram schematically showing a TFT substrate of an organic EL display device according to a second embodiment of the present invention.

FIG. 13 is a diagram schematically showing the circuit of a pixel shown in FIG. 12.

FIG. 14 is a timing chart showing changes of respective signals in the pixel shown in FIG. 13.

FIG. 15 is a diagram schematically showing the configuration of a data signal driving unit shown in FIG. 12.

### DETAILED DESCRIPTION OF THE INVENTION

Hereinafter, first and second embodiments of the present invention will be described with reference to the accompanying drawings. In the drawings, the same or equivalent elements will be denoted by the same reference numerals, and the same description thereof will not be repeated.

### First Embodiment

FIG. 1 is a diagram showing an organic EL display device 100 according to the first embodiment of the present invention. As shown in the drawing, the organic EL display device 100 includes an upper frame 110 and a lower frame 120 that fix an organic EL panel made up of a thin film transistor (TFT) substrate 200 and a sealing substrate (not shown) so as to be interposed therebetween, a circuit substrate 140 including a circuit element that generates display information, and a flexible substrate 130 that transfers RGB video signals generated in the circuit substrate 140 to the TFT substrate 200.

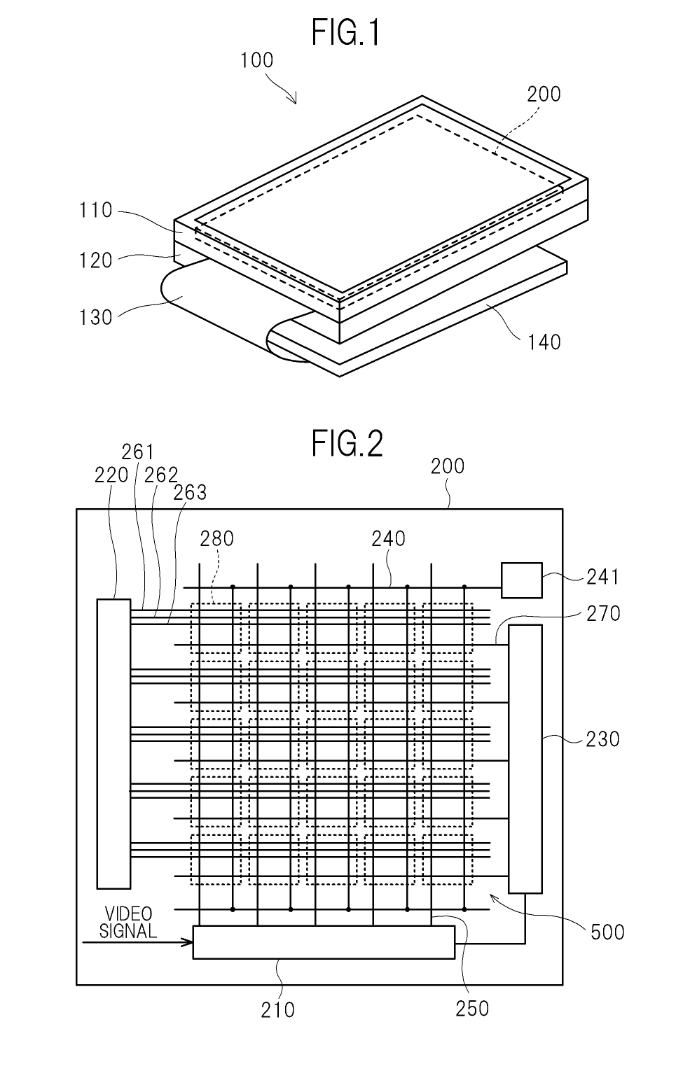

FIG. 2 schematically shows the TFT substrate 200 shown in FIG. 1. The TFT substrate 200 includes pixels 280 which are arranged in a matrix form and are the minimum units of display and which include any one of three organic light-emitting elements of the colors red (R), green (G), and blue (B), a data signal driving unit 210 that applies a data voltage corresponding to a gray level value to be displayed to a data signal line 250, a gate driving unit 220 that outputs a signal for controlling a plurality of TFT switches disposed in the respective pixels 280 to (gate) signal lines 261 to 263, an emission reference voltage signal driving unit 230 that outputs a rectangular-wave emission reference voltage signal for causing the light-emitting elements to emit light to an emission reference voltage signal line 270, and a power unit 241 connected to power lines 240 wired to the respective pixels 280. This drawing is simplified by decreasing the number of pixels 280 for better understanding of the drawing.

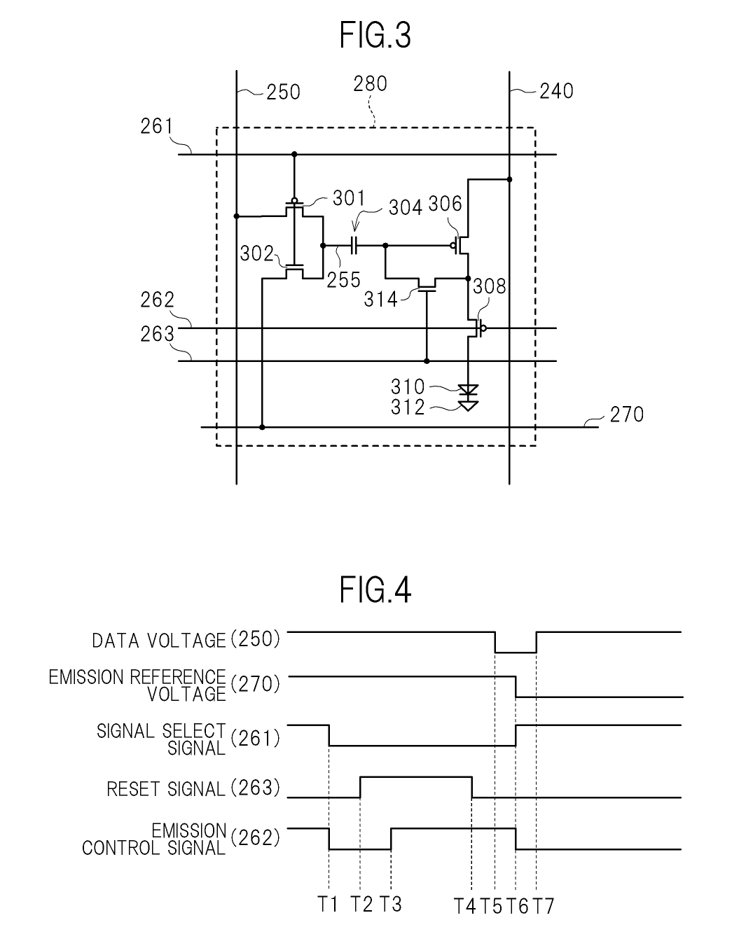

FIG. 3 schematically shows the circuit of the pixel 280. As shown in the drawing, the circuit of the pixel 280 includes an organic EL element 310 which is a self luminous body, a first select switch 301 and a second select switch 302 which are driven by a signal select signal input to a signal select signal line 261 so as to selectively connect one of the emission reference voltage signal line 270 and the data signal line 250 to an input signal line 255, a driving TFT 306 which functions as a switch that causes the organic EL element 310 to emit light and in which an anode side of the organic EL element 310 is connected to a drain side through an emission control switch 308 described later, a storage capacitor 304 that is disposed between the first and second select switches 301 and 302 and the gate side of the driving TFT 306, a reset switch 314 which is connected so as to connect the drain side and the gate side of the driving TFT 306 and which operates with a reset signal input to a reset signal line 263, an emission control switch 308 which is disposed on the drain side of the driving TFT 306 and which operates with an emission control signal input to an emission control signal line 262, and a common electrode 312 that is connected to the cathode side of the organic EL element 310. Moreover, the source side of the driving TFT 306 is connected to the power line 240.

Since the first select switch 301, the driving TFT 306, and the emission control switch 308 are formed by p-type MOS transistors, they are turned on when the gate signal is Low. On the other hand, since the second select switch 302 and the reset switch 314 are formed by n-type MOS transistors, they are turned on when the gate signal is High. In the present embodiment, the respective pixels perform display based on 64 gray levels of 0 to 63.

FIG. 4 is a timing chart showing changes of respective signals when the organic EL element 310 of the pixel 280 shown in FIG. 3 emits light. This timing chart shows the changes of the respective signals of the data voltage, the emission reference voltage, the signal select signal, the reset signal, and the emission control signal which are applied to the data signal line 250, the emission reference voltage signal line 270, the signal select signal line 261, the reset signal line 263, and the emission control signal line 262 shown in FIG. 3.

As shown in the drawing, first, at time T1, when both the signal select signal and the emission control signal become Low (Active), the first select switch 301 is turned on, and the second select switch 302 is turned off. Thus, the data voltage is input to the input signal line 255, and the emission control switch 308 is turned on. Subsequently, at time T2, the reset signal becomes High (Active), and the reset switch 314 is turned on, whereby the gate and the drain of the driving TFT 306 are conductive.

Subsequently, at time T3, when the emission control signal becomes High (Negative), the emission control switch 308 is turned off, and the gate voltage of the driving TFT 306 rises, and the driving TFT 306 becomes non-conductive at the time when the gate voltage becomes the threshold voltage of the driving TFT 306. At time T4, the reset switch 314 is turned off in response to the reset signal Low (Negative). At time T5, a data voltage is applied to the data signal line 250, and a voltage corresponding to the gray level voltage is stored in the storage capacitor 304.

At time T6, the signal select signal becomes High, an emission reference voltage is set to the emission reference voltage signal line 270, and the emission control signal becomes Low (Active). In this way, the emission control switch 308 is turned on, and the input signal line 255 is connected to the emission reference voltage signal line 270, and the emission reference voltage is applied to the input signal line 255. As a result, a voltage corresponding to the voltage stored in the storage capacitor 304 is applied to the gate of the driving TFT 306, and current flows from the source side to the drain side of the driving TFT 306, whereby the organic EL element 310 emits light.

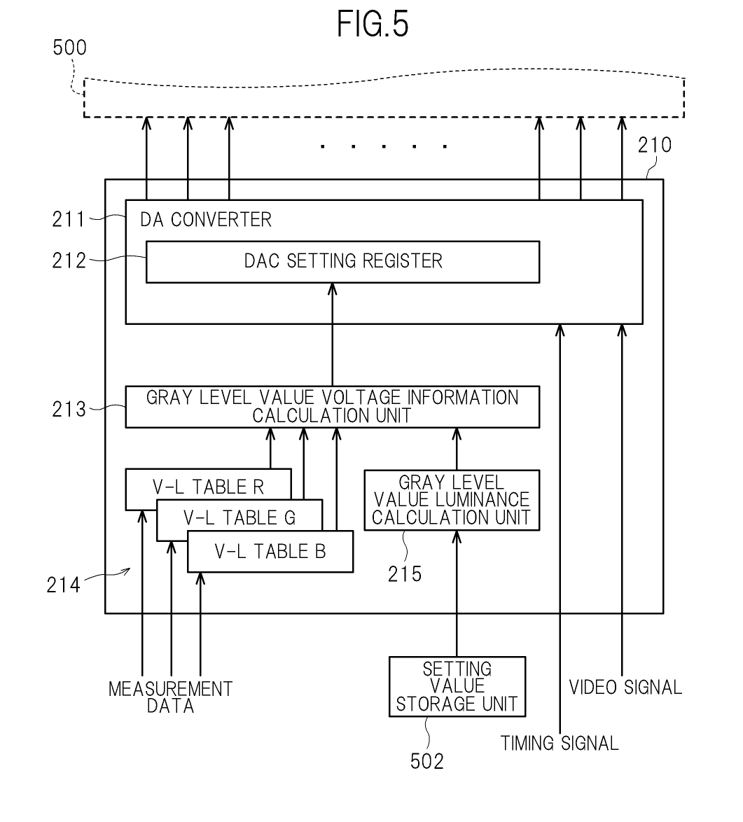

FIG. 5 schematically shows the configuration of the data signal driving unit 210. The data signal driving unit 210 includes a voltage luminance storage unit 214 that stores a V-L table R, a V-L table G, and a V-L table B which store the relationship between the voltage V applied to the respective colors RGB and a luminance L emitted by the voltage during inspection of products, a gray level value luminance calculation unit 215 that calculates the relationship between a gray level value D and a luminance L by reading the maximum luminance, the minimum luminance, a color temperature, RGB chromaticities, and the setting values of display characteristics, such as the y value of a y curve, representing the relationship between the gray level values of the respective colors RGB and the gate-source voltage of the driving TFT 306 from a setting value storage unit 502 in which the above mentioned information are stored, a gray level value voltage information calculation unit 213 that calculates the relationship between the gray level value D and the gate voltage V using the information supplied from the voltage luminance storage unit 214 and the gray level value luminance calculation unit 215, and a DA converter unit 211 that generates a 64-gray level voltage for each color and applies the gray level voltage to each column of a display area 500. The DA converter unit 211 includes a DAC setting register (gray level value voltage information register) 212 that stores the relationship between the gray level value D and the gate voltage V calculated by the gray level value voltage information calculation unit 213.

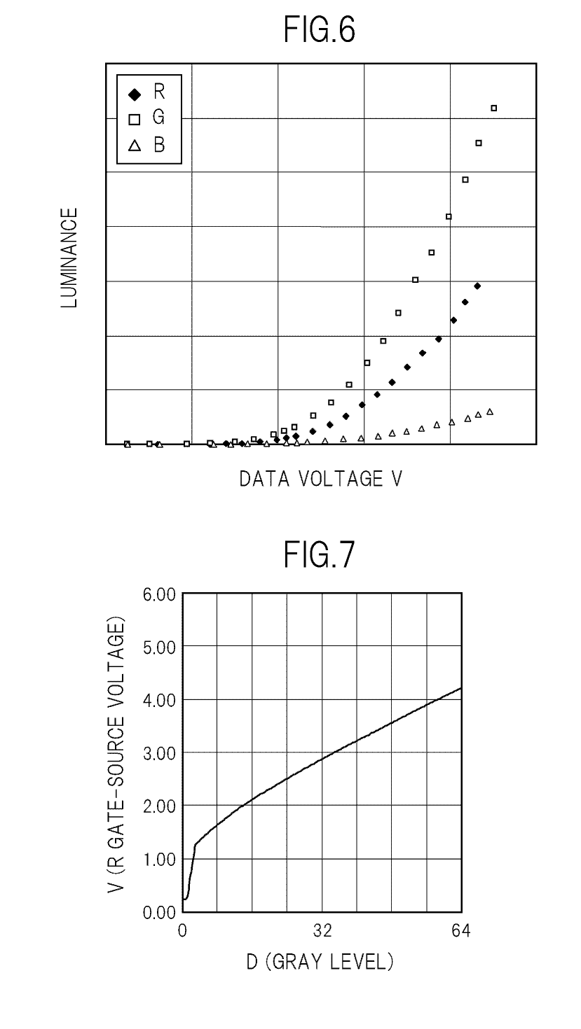

Next, the configuration shown in FIG. 5 will be described in further detail in accordance with the processing flow. First, the characteristics of a driver output voltage and luminance are measured for each panel or for each manufacturing lot during inspection of products and are written to the voltage luminance storage unit 214 with respect to each of the colors RGB. Here, the voltage luminance storage unit 214 may store the characteristics in a lookup table format or in an approximate expression. FIG. 6 shows a graph showing an example of measurement data stored in the voltage luminance storage unit 214.

Next, the gray level value luminance calculation unit 215 calculates the relationship between the gray level value D and the luminance L based on the data stored in the setting value storage unit 502 in which the maximum luminance, the minimum luminance, a color temperature, RGB chromaticities, and the y value of a y curve representing the relationship between the gray level values of the respective colors RGB and the gate-source voltage of the driving

TFT 306 are stored as the setting parameters of the organic EL display device 100. For example, the W (white) luminance is represented by Equation (1), the luminance rates of the respective gray levels are calculated using the color temperature of white and the chromaticities of the respective colors RGB.

W Luminance=(Maximum Luminance)×(D/255)^{γ}+(Minimum Luminance) (1)

When the tristimulus values of the respective color are X, Y, and Z, and the luminance rates thereof are Rᵣₐₜₑ, Gᵣₐₜₑ, Bᵣₐₜₑ, the luminance rates of the tristimulus values are calculated by Equation (2).

$$( \begin{matrix}{X}_{W} \\ {Y}_{W} \\ {Z}_{W}\end{matrix} ) = ( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} ) ( \begin{matrix}{R}_{rate} \\ {G}_{rate} \\ {B}_{rate}\end{matrix} ) \qquad ( 2 )$$

Furthermore, the luminances of respective gray levels and the respective colors are calculated using the relationship of Equation (3).

W Luminance (D)=(R Luminance (D))+(G Luminance (D))+(B Luminance (D)) (3)

The gray level value voltage information calculation unit 213 calculates the relationship between the gray level value D and the gate voltage V for each of the respective colors RGB using the relationship between the gray level value D and the luminance L calculated by the gray level value luminance calculation unit 215 and the measurement data written to the voltage luminance storage unit 214. The calculated relationship between the gray level value D and the gate voltage V is stored in the DAC setting register 212 of the DA converter unit 211.

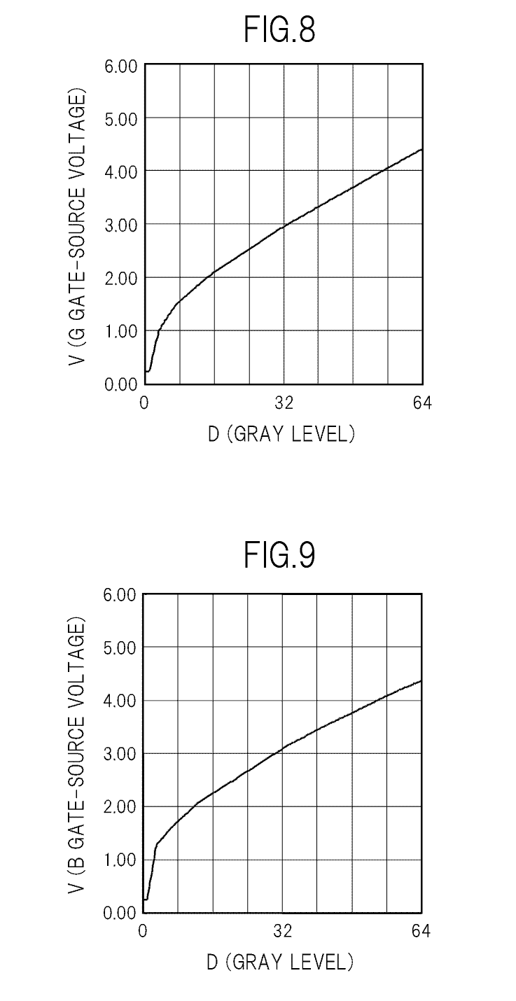

FIGS. 7 to 9 are graphs showing the relationship between the gray level value D and the gate-source voltage V of each of the respective colors RGB. As shown in the graphs, it can be understood that the gate-source voltage changes abruptly in the lower gray level range among all 64 gray levels, and the gate-source voltage changes moderately in the high gray level range.

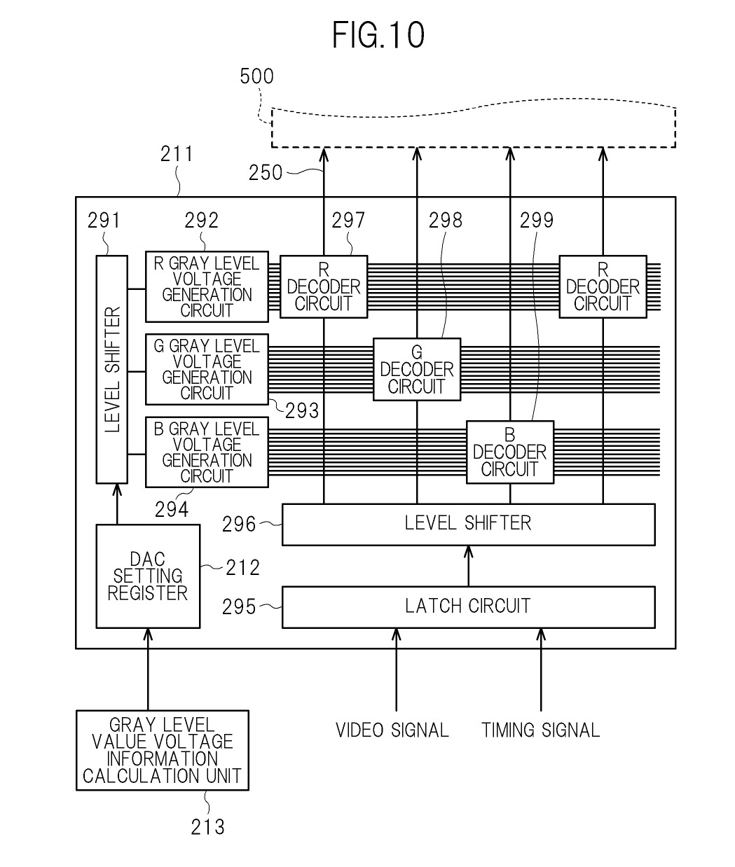

FIG. 10 schematically shows the configuration of the DA converter unit 211. The DA converter unit 211 includes the DAC setting register 212 that stores the relationship between the gray level value D and the gate voltage V, a level shifter 291 for voltage generation circuit of each of the colors RGB, a R gray level voltage generation circuit 292 that generates respective gray level voltages for red, a G gray level voltage generation circuit 293 that generates respective gray level voltages for green, a B gray level voltage generation circuit 294 that generates respective gray level voltages for blue, a latch circuit 295 that receives a video signal and a timing signal and outputs the digital value of a gray level value to respective signal lines, a level shifter 296 for the digital value of the gray level value, and an R decoder circuit 297, a G decoder circuit 298, and a B decoder circuit 299 that select voltages corresponding to respective gray level values from the respective gray level voltages generated in the respective gray level voltage generation circuits 292 to 294 and apply the selected voltages to the data signal line 250. The relationship between the gray level value D and the gate voltage V set in the DAC setting register 212 is used for controlling the voltage values generated by the gray level voltage generation circuits 292 to 294 of the respective colors RGB through the level shifter 291.

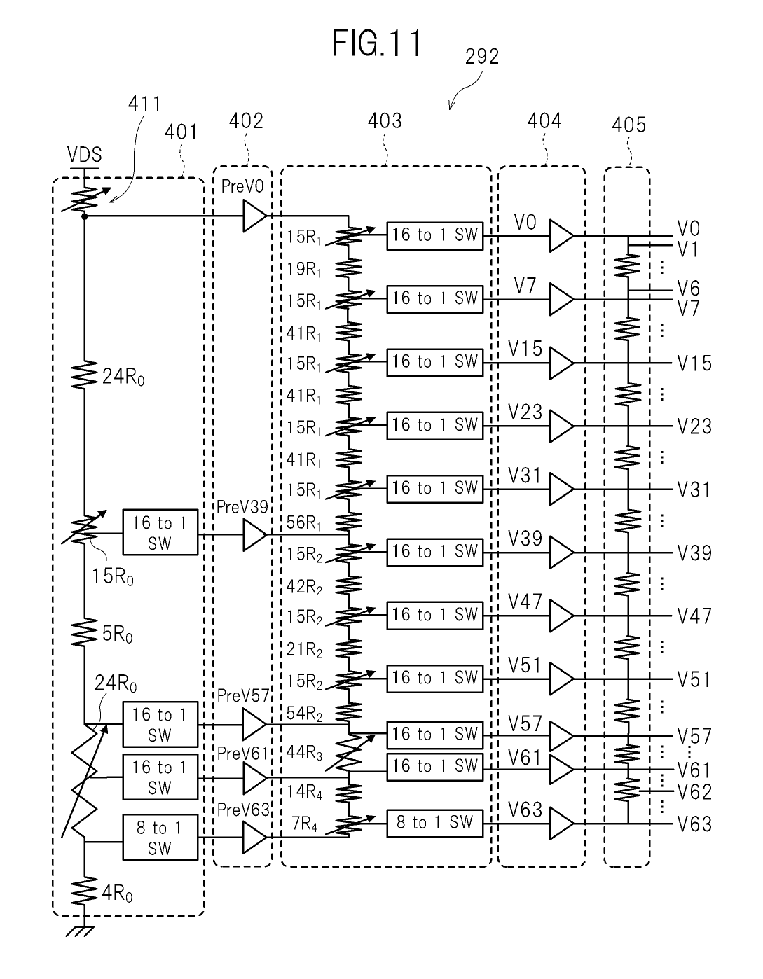

FIG. 11 schematically shows the inner circuits of the R gray level voltage generation circuit 292. The R gray level voltage generation circuit 292 includes a first ladder resistor unit 401, a first buffer unit 402, a second ladder resistor unit 403, a second buffer unit 404, and a third ladder resistor unit 405. The first ladder resistor unit 401 includes a series of resistors of which the resistance values are 4R₀, 24R₀, 5R₀, 15R₀, and 24R₀ from the ground side (where R₀ is 5 KΩ) and is connected to a power voltage VDH through a variable adjustment resistor 411. Here, 24R₀ and 15R₀ resistors are variable resistors, two 16-step switches and one 8-step switches are connected to the 24R₀ resistor, and one 16-step switch is connected to the 15R₀ resistor. Thus, the number of output terminals in the upper 1/4 gray level range of the entire gray level range of the first ladder resistor unit 401 is 3, and the number of output terminals in the lower 1/4 gray level range is 1.

Therefore, the number of output terminals in the upper 1/4 gray level range of the entire gray level range of the first ladder resistor unit 401 is larger than the number of output terminals in the lower 1/4 gray level range. Moreover, since the high gray level range where the voltage variation is moderate can be set finely, it is possible to reflect the gray level value-voltage characteristics of the display device more accurately.

The voltages PreV0, PreV39, PreV57, PreV61, and PreV63 of five steps in total output from the first ladder resistor unit 401 are input to the first buffer unit 402. The respective outputs of five steps having passed through the first buffer unit 402 are input to the second ladder resistor unit 403. The second ladder resistor unit 403 includes ten variable resistors and nine fixed resistors connected between the respective variable resistors, and outputs voltages of 11 steps in total from the respective variable resistors.

In the drawing, a resistance value R₁ is 2 kΩ, R₂ is 5 kΩ, R₃ is 10 kΩ, and R₄ is 20 kΩ. The number of output terminals in the upper 1/4 gray level range of the entire gray level range of the second ladder resistor unit 403 is 5, and the number of output terminals in the lower 1/4 gray level range is 3. Therefore, the number of output terminals in the upper 1/4 gray level range of the entire gray level range of the second ladder resistor unit 403 is larger than the number of output terminals in the lower 1/4 gray level range. Moreover, since the high gray level range where the voltage variation is moderate can be set finely, it is possible to reflect the gray level value-voltage characteristics of the display device more accurately.

The 11 steps of gray level voltage taken from the respective variable resistors V0, V7, V15, V23, V31, V39, V47, V51, V57, V61, and V63 are input to the second buffer unit 404. The respective gray level voltages of eleven steps having passed through the second buffer unit 404 are divided into a number of voltages corresponding to the number of gray levels between the respective gray levels in the third ladder resistor unit 405 and are output as 64 gray level voltages of V0 to V63 as a whole. The G gray level voltage generation circuit 293 and the B gray level voltage generation circuit 294 have the same circuit configuration as the R gray level voltage generation circuit 292.

As described above, according to the first embodiment of the present invention, it is possible to reflect the gray level value-voltage characteristics of the respective colors shown in FIGS. 7 to 9 during display more accurately.

### Second Embodiment

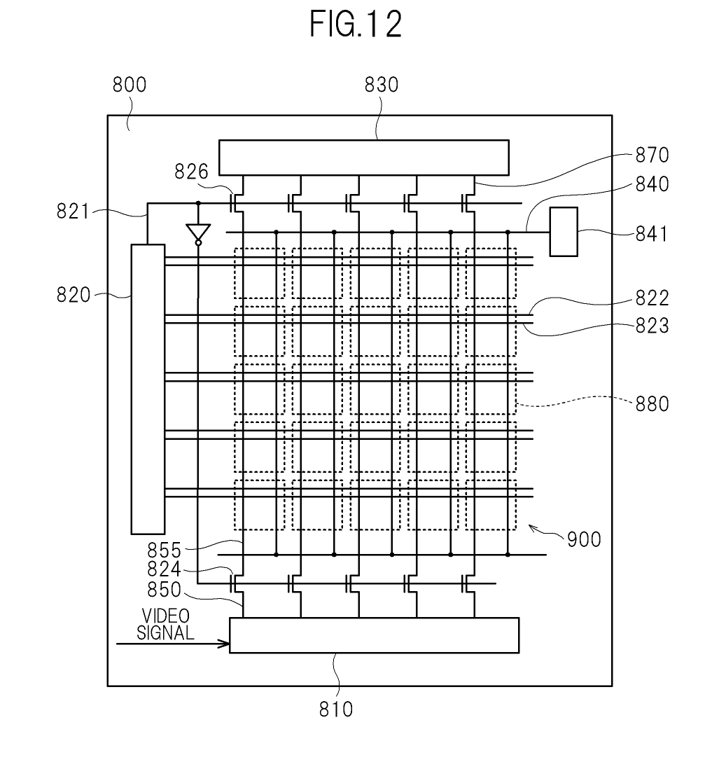

FIG. 12 schematically shows a TFT substrate 800 according to the second embodiment of the present invention. Here, an organic EL display device in which the TFT substrate 800 is housed is the same as the organic EL display device 100 of the first embodiment shown in FIG. 1, and the description thereof will not be provided.

As shown in FIG. 12, the TFT substrate 800 includes pixels 880 which are arranged in a matrix form and are the minimum units of display and which include any one of three organic light-emitting elements of the colors red (R), green (G), and blue (B), a data signal driving unit 810 that applies a data voltage corresponding to a gray level value to be displayed to a data signal line 850, a gate driving unit 820 that outputs a signal for controlling a plurality of TFT switches disposed in the respective pixels 880 to (gate) signal lines 822 and 823, a first select switch 824 and a second select switch 826 that selectively connect one of an emission reference voltage signal line 870 and a data signal line 850 to an input signal line 855 in accordance with the signal of the signal select signal line 821, an emission reference voltage signal driving unit 830 that outputs a rectangular-wave emission reference voltage signal for causing the light-emitting elements to emit light to an emission reference voltage signal line 870, and a power unit 841 connected to power lines 840 wired to the respective pixels 880. Similarly to FIG. 2 of the first embodiment, this drawing is simplified by decreasing the number of pixels 880 for better understanding of the drawing.

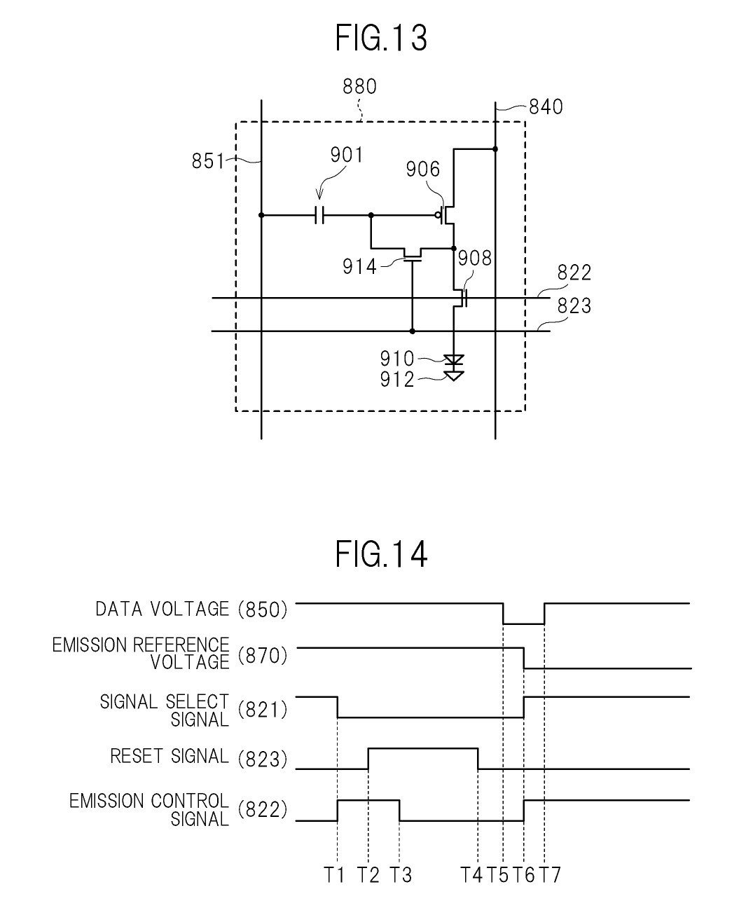

FIG. 13 is a diagram schematically showing the circuit in the pixel 880. As shown in the drawing, the pixel 880 includes an organic EL element 910 which is a self luminous body, a driving TFT 906 which functions as a switch that drives the organic EL element 910 and in which an anode side of the organic EL element 910 is connected to a drain side through an emission control switch 908 described later, a storage capacitor 901 that is disposed on the gate side of the driving TFT 906, a reset switch 914 which is connected so as to connect the drain side and the gate side of the driving TFT 906 and which operates with a reset signal applied to a reset signal line 823, an emission control switch 908 which is disposed on the drain side of the driving TFT 906 and which is driven by an emission control signal, and a common electrode 912 that is connected to the cathode side of the organic EL element 910. Moreover, the source side of the driving TFT 906 is connected to the power line 840.

Unlike the first embodiment, since the emission control switch 908 is formed by an n-type MOS transistor, the emission control switch 908 is turned on when the gate signal is High.

FIG. 14 shows a timing chart showing changes of the signals controlled when the organic EL element 910 of the pixel 880 shown in FIG. 13 emits light. In the second embodiment, since the emission control switch 908 is formed by an n-type MOS transistor, in this timing chart, the Low and High polarities of the emission control signal are reversed from those of the emission control signal of the first embodiment. The other signals are the same as those of the timing chart of the first embodiment shown in FIG. 4 and the same operation is performed. Thus, the description thereof will not be provided.

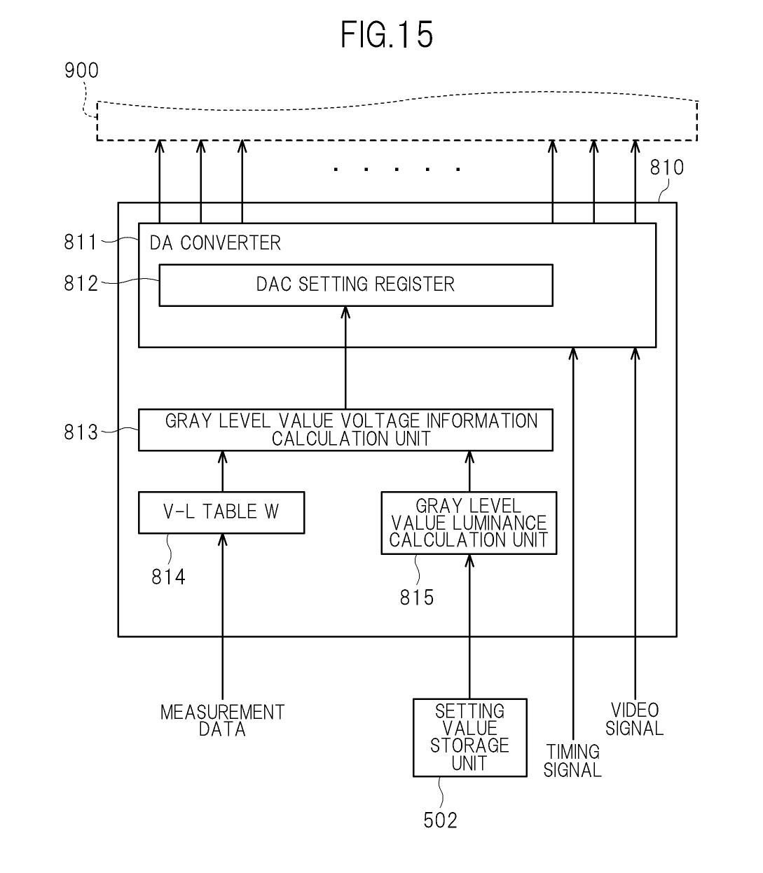

FIG. 15 shows the configuration of the data signal driving unit 810. The data signal driving unit 810 includes a voltage luminance storage unit 814 that stores a V-L table for W (white) representing the relationship between the voltage V applied to the respective colors RGB and a luminance L emitted by the voltage during inspection of products, a gray level value luminance calculation unit 815 that calculates the relationship between a gray level value D and a luminance L by reading the maximum luminance, the minimum luminance, a color temperature, RGB chromaticities, and the setting values of display characteristics, such as the y value of a y curve, representing the relationship between the gray level values of the respective colors RGB and the gate-source voltage of the driving TFT 906 from a setting value storage unit 502 in which the above mentioned information are stored, a gray level value voltage information calculation unit 813 that calculates the relationship between the gray level value D and the gate voltage V using the information supplied from the voltage luminance storage unit 814 and the gray level value luminance calculation unit 815, and a DA converter unit 811 that generates a 64-gray level voltage for each color and applies the gray level voltage to each column of a display area 900. The DA converter unit 811 includes a DAC setting register (gray level value voltage information register) 812 for causing the DA converter unit 811 to realize the relationship between the gray level value D and the gate voltage V calculated by the gray level value voltage information calculation unit 813.

Next, the configuration shown in FIG. 15 will be described in further detail in accordance with the processing flow. First, the characteristics of a driver output voltage and luminance are measured for each panel or for each manufacturing lot during inspection of products and are written to the voltage luminance storage unit 814. Here, the voltage luminance storage unit 814 may store the characteristics in a lookup table format or in an approximate expression.

Next, the gray level value luminance calculation unit 815 calculates the relationship between the gray level value D and the luminance L based on the data stored in the setting value storage unit 502 in which the maximum luminance, the minimum luminance, a color temperature, RGB chromaticities, and the γ value of a γ curve representing the relationship between the gray level values of the respective colors RGB and the gate-source voltage of the driving TFT 906 are stored as the setting parameters of the organic EL display device 100. For example, the W (white) luminance is represented by Equation (1), the luminance rates of the respective gray levels are calculated using the color temperature of white and the chromaticities of the respective colors RGB.

W Luminance=(Maximum Luminance)×(D/255)^{γ}+(Minimum Luminance) (4)

The luminances (D) of the respective colors RGB are calculated by Equation (5) using luminance rates R_{rate, G}_{rate, and B}_{rate.}

R Luminance (D)=(W Luminance)×(Rᵣₐₜₑ) (D)

G Luminance (D)=(W Luminance)×(Gᵣₐₜₑ) (D)

B Luminance (D)=(W Luminance)×(Bᵣₐₜₑ) (D) (5)

Furthermore, the voltage luminance storage unit 814 calculates the luminance L to the voltage V of the respective colors using the relationship of Equation (6).

R Luminance (V)=(W Luminance)×(Rᵣₐₜₑ) (V)

G Luminance (V)=(W Luminance)×(Gᵣₐₜₑ) (V)

B Luminance (V)=(W Luminance)×(Bᵣₐₜₑ) (V) (6)

The gray level value voltage information calculation unit 813 calculates the relationship between the gray level value D and the gate voltage V for each of the respective colors RGB using the relationship between the gray level value D and the luminance L calculated by the gray level value luminance calculation unit 815 and the measurement data written to the voltage luminance storage unit 814. The calculated relationship between the gray level value D and the gate voltage V is stored in the DAC setting register 812 of the DA converter unit 811. Since the configuration of the DA converter unit 811 is the same as that shown in FIG. 10 of the first embodiment, the redundant description thereof will not be provided. As described above, according to the second embodiment of the present invention, it is possible to reflect the gray level value-voltage characteristics of the display device during display more accurately.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A light-emitting element display device comprising:
a setting value storage unit that stores setting values regarding display quality;
a gray level value luminance calculation unit that calculates the relationship between a gray level value and a luminance from the setting values stored in the setting value storage unit;
a voltage luminance storage unit that stores the relationship between an applied voltage and the luminance of a light-emitting element,
a gray level value voltage information calculation unit that calculates gray level value voltage information which is the relationship between the gray level value and the voltage using the information supplied from the gray level value luminance calculation unit and the voltage luminance storage unit; and
a DA converter unit of which an output voltage is controlled by the calculated gray level value voltage information and which outputs the voltage corresponding to each gray level value,
wherein the DA converter unit includes a first ladder resistor unit and a second ladder resistor unit each including variable resistors, a third ladder resistor unit including a number of output terminals corresponding to the number of gray levels, and a gray level value voltage information register that stores the gray level value voltage information, and
wherein the variable resistors are controlled by the gray level value voltage information stored in the gray level value voltage information register.

2. The light-emitting element display device according to claim 1,
wherein the first ladder resistor unit receives an upper reference voltage and a lower reference voltage at both ends thereof and outputs a plurality of kinds of voltages,
wherein the second ladder resistor unit receives the plurality of kinds of output voltages and outputs a number of voltages larger than the plurality of kinds of voltages received, and
wherein the third ladder resistor unit receives the voltages output by the second ladder resistor unit and outputs a number of voltages corresponding to the number of gray levels.

3. The light-emitting element display device according to claim 1,
wherein in the first ladder resistor unit and the second ladder resistor unit, the number of output terminals in the upper 1/4 gray level range of the entire gray level range is larger than the number of output terminals in the lower 1/4 gray level range.

4. The light-emitting element display device according to claim 1,
wherein the first ladder resistor unit outputs five kinds of voltages,
wherein the second ladder resistor unit outputs eleven kinds of voltages, and
wherein the third ladder resistor unit outputs 64 kinds of voltages which correspond in number to the number of gray levels.

5. The light-emitting element display device according to claim 1,
wherein the voltage luminance storage unit independently stores the luminances of the respective colors RGB.
